(19) United States
(12) Patent Application Publication
(10) Pub. No.: US 2017/0194898 A1
(43) Pub. Date: Jul. 6, 2017

(54) SOLAR PANEL CLEANING SYSTEM CAPABLE OF CLEANING A PLURALITY OF SOLAR ARRAYS

(71) Applicant: Ecoppia Scientific Ltd., Herzliya, IL (US)

(72) Inventors: Moshe Meller, Tel Aviv (IL); Eran Meller, Tel Aviv (IL)

(21) Appl. No.: 15/136,172

(22) Filed: Apr. 22, 2016

Related U.S. Application Data
(60) Provisional application No. 62/274,800, filed on Jan. 5, 2016.

(51) Int. Cl. H02S 40/10; H02S 30/00

(52) U.S. Cl. CPC H02S 40/10; H02S 30/00

(57) ABSTRACT

The present invention is a cleaning system for solar panels in a solar park capable of cleaning a plurality of solar arrays without water. Some embodiments of the system include a first set of ground based rails positioned substantially in between two neighboring solar arrays and parallel to a length direction of the solar arrays, a second set of ground based rails positioned perpendicularly to the length direction of the solar arrays and including a plurality of sensors, a moveable transport platform capable of moving along the second set of ground based rails, the platform including two descent rails, a plurality of wheels, a position sensor, a first controller, and a power supply, and an automatic waterless cleaning apparatus positioned on the moveable transport platform and capable of moving along the first set of ground based rails along the length direction of the solar arrays.

### CROSS-REFERENCE TO RELATED APPLICATIONS

This application claims the benefit of, and priority to, U.S. Provisional Application Ser. No. 62/274,800, filed Jan. 5, 2016, the contents of which are hereby incorporated by reference herein in their entirety.

### FIELD

The disclosed technique relates to solar arrays, in general, and to methods and systems for cleaning a plurality of solar arrays, in particular.

### BACKGROUND

In order to bring solar energy cost production to par with petroleum, the efficiency of solar energy systems must improve. The efficiency of solar panels depends amongst other things on the cleanliness of their surfaces. Due to dust and soiling, energy losses of solar panels can reach in some cases up to 40%. Currently existing cleaning processes and devices of solar panels are costly, labor intensive, and consume a high volume of water.

### SUMMARY OF THE PRESENT DISCLOSED TECHNIQUE

It is an object of the disclosed technique to provide a novel method and system for transferring a single automatic waterless cleaning apparatus from one solar array to another. In accordance with the disclosed technique, there is thus provided a cleaning system for solar panels in a solar park capable of cleaning a plurality of solar arrays without water. The cleaning system includes a first set of ground based rails, a second set of ground based rails, a moveable transport platform and an automatic waterless cleaning apparatus. The first set of ground based rails is positioned substantially in between two neighboring solar arrays parallel to a length direction of the solar arrays. The second set of ground based rails is positioned perpendicularly to the length direction of the solar arrays. The moveable transport platform is capable of moving along the second set of ground based rails. The automatic waterless cleaning apparatus is capable of moving along the first set of ground based rails along the length direction of the solar arrays and is positioned on the moveable transport platform. The second set of ground based rails includes a plurality of sensors. The moveable transport platform includes two descent rails, a plurality of wheels, a position sensor, a first controller and a power supply. The two descent rails are coupled with a surface of the moveable transport platform. The wheels are for moving the moveable transport platform along the second set of ground based rails. The first controller is for controlling the movement of the moveable transport platform. The automatic waterless cleaning apparatus includes at least four wheels, a second controller, a transmission and at least one electrical motor. The wheels are for moving the automatic waterless cleaning apparatus along the first set of ground based rails and the second controller is for controlling a boarding and alighting of the automatic waterless cleaning apparatus from the moveable transport platform. A distance between the wheels is substantially the same as a distance between neighboring ones of the first set of ground based rails.

In accordance with another aspect of the disclosed technique, there is thus provided a method for operating a cleaning system for solar panels in a solar park capable of cleaning a plurality of solar arrays without water. The cleaning system includes a first set of ground based rails, a second set of ground based rails, a moveable transport platform and an automatic waterless cleaning apparatus. The first set of ground based rails is positioned substantially in between two neighboring solar arrays, parallel to a length direction of the solar arrays. The second set of ground based rails is positioned perpendicularly to the length direction of the solar arrays. The moveable transport platform is capable of moving along the second set of ground based rails and the automatic waterless cleaning apparatus is positioned on the moveable transport platform. The second set of ground based rails includes a plurality of sensors. The moveable transport platform includes two descent rails, a plurality of wheels, a position sensor, a controller and a power supply. The wheels are for moving the moveable transport platform along the second set of ground based rails. The controller is for controlling the movement of the moveable transport platform.

The method includes the procedures of receiving a start cleaning command by the controller, moving the moveable transport platform to a first parking position along the second set of ground based rails and alighting the automatic waterless cleaning apparatus from the moveable transport platform from the two descent rails onto a neighboring two of the first set of ground based rails. The method also includes the procedures of cleaning a first one of the solar arrays using the automatic waterless cleaning apparatus, boarding the automatic waterless cleaning apparatus onto the moveable transport platform from the neighboring two of the first set of ground based rails onto the moveable transport platform and moving the moveable transport platform to a second parking position along the second set of ground based rails. The first parking position is determined by the controller, the position sensor and the plurality of sensors.

### BRIEF DESCRIPTION OF THE DRAWINGS

The disclosed technique will be understood and appreciated more fully from the following detailed description taken in conjunction with the drawings in which:

FIG. 1 is a top view of the cleaning system of the disclosed technique, wherein an automatic cleaning apparatus cleans a first solar array, constructed and operative in accordance with an embodiment of the disclosed technique;

FIG. 2 is a side cross sectional view of the cleaning system along line A-A of FIG. 1, constructed and operative in accordance with another embodiment of the disclosed technique;

FIG. 3 is a top view of the cleaning system of the disclosed technique wherein the cleaning apparatus is on the transport platform and is moving from the first solar array towards a second solar array, constructed and operative in accordance with a further embodiment of the disclosed technique;

FIG. 4 is a cross sectional view of the cleaning system and the automatic cleaning apparatus along line B-B of FIG. 3, constructed and operative in accordance with another embodiment of the disclosed technique; and

FIG. 5 is a top view of the cleaning system of the disclosed technique wherein the cleaning apparatus is off the transport platform and is cleaning the second solar array, constructed and operative in accordance with a further embodiment of the disclosed technique.

### DETAILED DESCRIPTION

The disclosed technique overcomes the disadvantages of the prior art by providing both a system and a method which provides a simple and efficient solution of transferring a single automatic cleaning apparatus from one solar array to another. The invention can be operated in two types of solar parks. Each solar park has plurality of solar arrays. In the first type of solar park the solar panel arrays have a fix tilt angle towards the sun. In the second type of solar park each solar array includes a plurality of solar trackers. Each tracker has a frame and solar panels that are assembled to the frame. Whole tracker units can rotate angularly to follow the sun from morning to evening.

The cleaning system of the disclosed technique comprises a first set of ground based rails that is positioned substantially in between two neighboring solar arrays, parallel to the length direction of the solar arrays, and a second set of ground based rails that is positioned perpendicularly to the length direction of the solar arrays. The automatic cleaning apparatus mentioned above is well known in the industry and will not be described herein in further detail. A specific preferred cleaning apparatus for use with the cleaning system of the disclosed technique is described in detail in U.S. provisional patent application No. 62/252,519 filed on Nov. 8, 2015. It is noted that other types of automatic waterless cleaning apparatuses that are moveable on the first set of ground based rails can be used and operated according to the system and method of the disclosed technique.

An object of the disclosed technique is to provide a system and a method wherein a plurality of solar arrays can be cleaned automatically by a single robotic cleaning apparatus without using water. Another object of the disclosed technique is to provide a system and a method that can clean both fixed type solar arrays as well as solar tracker type solar arrays without using water. A further object of the disclosed technique is to provide such a system and method for cleaning solar arrays that requires minimal maintenance and supervision and is cost effective.

### Description of Operation

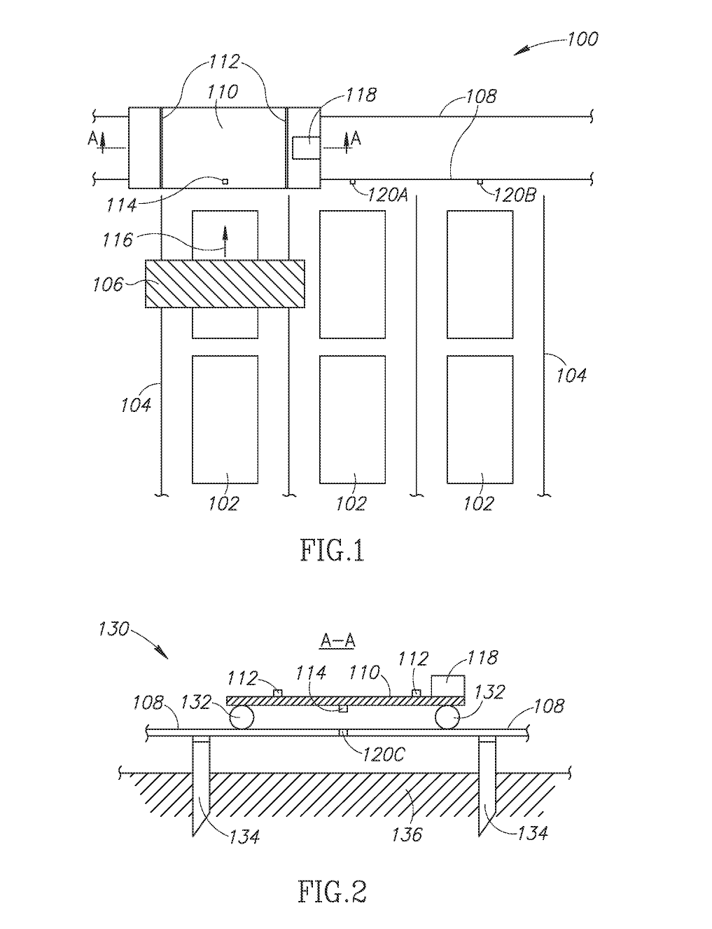

Reference is now made to FIG. 1 which is a top view of the cleaning system of the disclosed technique, generally referenced 100, wherein an automatic cleaning apparatus cleans a first solar array, constructed and operative in accordance with an embodiment of the disclosed technique. It is noted that identical reference numbers are used throughout the figures to refer to identical components and elements. Cleaning system 100 includes a plurality of solar arrays 102 in a solar park that need to be cleaned. As previously explained, these solar arrays can be either fixed type solar arrays or tracker type solar arrays. In the case of a tracker type, the solar arrays should be brought to a predetermined angular position in order to be cleaned automatically. Cleaning system 100 also includes a first plurality of rails 104 that an automatic cleaning apparatus 106 can move along the solar arrays while automatically cleaning solar arrays 102. Plurality of rails 104 is ground based and the height of each rail is fixed relative to the solar arrays and not relative to the ground terrain in order to allow for automatic cleaning of solar arrays 102. Automatic cleaning apparatus 106 is a cleaning apparatus that can be any waterless cleaning apparatus for cleaning solar arrays provided it can move on plurality of rails 104 along the length direction of solar arrays 102. Automatic cleaning apparatus 106 has the form of a bridge over plurality of solar arrays 102. Its angle (as shown below in FIG. 4) should be parallel to the tilt angle in a fixed type solar park or to a predetermined cleaning angle in a tracker type solar park. Cleaning system 100 further includes a second plurality of rails 108 that are positioned perpendicular to the length direction of solar arrays 102. Plurality of rails 108 is ground based and each rail is positioned relative to the height of first plurality of rails 104. The height of plurality of rails 108 is lower than the height of plurality of rails 104. Cleaning system 100 also includes a moveable transport platform 110 that can move along plurality of rails 108. Two descent rails 112 are fixed to the surface of transport platform 110, shown in greater detail in FIG. 2. The height level of descent rails 112 is substantially the same as the height level of plurality of rails 104. In a parking position of transport platform 110, descent rails 112 create a continuation of a respective two of plurality of rails 104 such that cleaning apparatus 106 can move seamlessly from descent rails 112 to plurality of rails 104. The parking position determines the height level of plurality of rails 108 relative to plurality of rails 104. Transport platform 110 includes a sensor 114 and plurality of rails 108 includes a plurality of sensors 120A and 120B. Sensor 114 and either one of sensors 120A and 120B form a sensor couple that can accurately position transport platform 110 at consecutive parking positions. Sensor 114 and sensors 120A and 120B can be embodied respectively as a magnetic sensor and a magnet, a proximity sensor and a piece of metal or other types of sensor pairs. An arrow 116 represents the movement direction of cleaning apparatus 106 along one of solar arrays 102. Transport platform 110 includes a controller 118 and a power supply (not shown). The power supply may be batteries.

Reference is now made to FIG. 2 which is a side cross sectional view of the cleaning system along line A-A of FIG. 1, generally referenced 130, constructed and operative in accordance with another embodiment of the disclosed technique. FIG. 2 shows that transport platform 110 includes a plurality of wheels 132. The rotation of the wheels 132 moves transport platform 110 on plurality of rails 108. Wheels 132 are driven by at least one electrical motor (not shown) and a transmission (not shown) that are well known to those skilled in the art. Plurality of rails 108 are coupled with a plurality of ground bases 134. Ground bases 134 determine the height of plurality of rails 108 relative to the height of plurality of rails 104. Ground level is shown by an arrow 136. As shown in FIG. 1, controller 118 and a battery power supply (not shown) are coupled with transport platform 110. Shown as well is sensor 120C which was not visible in FIG. 1. When transport platform 110 is parked, sensor 114 is in line with the particular sensor on plurality of rails 108 over a given solar array; as shown in FIG. 2, sensor 114 is in line with sensor 120C.

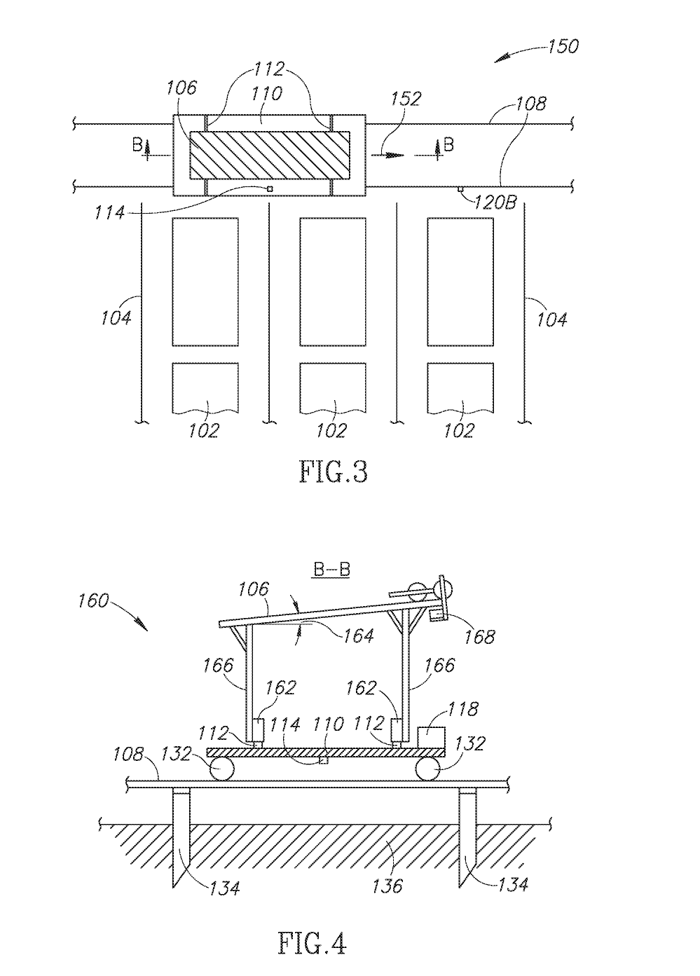

Reference is now made to FIG. 3 which is a top view of the cleaning system of the disclosed technique wherein the cleaning apparatus is on the transport platform and is moving from the first solar array towards a second solar array, generally referenced 150, constructed and operative in accordance with a further embodiment of the disclosed technique. As shown, automatic cleaning apparatus 106 is on transport platform 110 and is moving towards the next parking position where the cleaning of the second solar array starts. An arrow 152 shows the direction of movement of transport platform 110. The position of cleaning apparatus 106 on transport platform 110 can be set by an indicator such as by mechanical stoppers (not shown) or by proximity sensors (not shown).

Reference is now made to FIG. 4 which is a cross sectional view of the cleaning system and the automatic cleaning apparatus along line B-B of FIG. 3, generally referenced 160, constructed and operative in accordance with another embodiment of the disclosed technique. Automatic cleaning apparatus 106 has a bridge shape with four supporting legs 166. An angle 164 is the tilt angle in a fixed type solar array or the predetermined cleaning angle in a solar tracker type solar array. A detailed technical description of a preferred embodiment of automatic cleaning apparatus 106 is described in U.S. Pat. No. 8,771,432 B2 and in U.S. provisional patent application No. 62/252,519, entitled “Solar Trackers Cleaning System and Method” filed on Nov. 8, 2015. As mentioned above, other types of waterless cleaning apparatuses can be used with the disclosed technique. Cleaning apparatus 106 includes at least four wheels 162 and a controller 168. Wheels 162 enable cleaning apparatus 106 to move along plurality of rails 104. The distance between wheels 162 is the same as the distance between two neighboring ones of plurality of rails 104. Wheels 162 are driven by at least one electrical motors and transmissions (both not shown). These types of electrical motors and transmissions are well known to those skilled in the art and are not detailed in the figures.

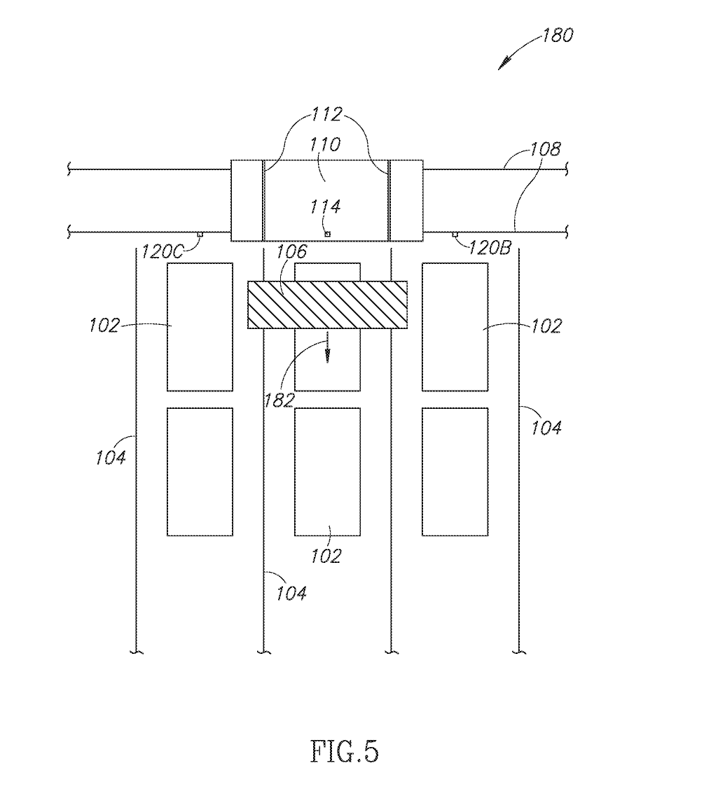

Reference is now made to FIG. 5 which is a top view of the cleaning system of the disclosed technique wherein the cleaning apparatus is off the transport platform and is cleaning the second solar array, generally referenced 180, constructed and operative in accordance with a further embodiment of the disclosed technique. As shown, automatic cleaning apparatus 106 is moving on plurality of rails 104 in the direction of an arrow 182, cleaning a neighboring solar array 102.

### Description of Operation

At starting point, cleaning apparatus 106 is parked on transport platform 110. When a start cleaning command is received by controller 118, transport platform 110 moves to a first parking position along plurality of rails 108. The accuracy of the parking position is controlled by controller 118 and by sensors 114 and 120A and 120B. At a first parking point, cleaning apparatus 106 gets off transport platform 110 and moves from descent rails 112 on transport platform 110 to plurality of rails 104 positioned in between solar arrays 102. The cleaning process of the first solar array thus starts. When the cleaning process of the first solar array is completed, cleaning apparatus 106 moves back towards transport platform 110. Cleaning apparatus 106 then moves from plurality of rails 102 onto descent rails 112 on transport platform 110. Transport platform 110 then moves to a next parking position along plurality of rails 108 where cleaning apparatus 106 gets off of transport platform 110 and the cleaning process of the second solar array starts.

The cleaning process and the boarding and alighting process of cleaning apparatus 106 from transport platform 110 are controlled by controller 168 of automatic cleaning apparatus 106. The movement and parking of transport platform 110 along plurality of rails 108 are controlled by controller 118 of transport platform 110. Communication between controller 118 and controller 168 can be conducted via wireless communication protocols such as ZigBee or any other known communication protocols. Following the completion of the cleaning of the second solar array, the cleaning process can continue to any number of preprogrammed solar arrays. The number of cleaned solar arrays can also be limited by time, by weather conditions or by power supply limitations.

It will be appreciated by persons skilled in the art that the disclosed technique is not limited to what has been particularly shown and described hereinabove. Rather the scope of the disclosed technique is defined only by the claims, which follow

1. A cleaning system for solar panels in a solar park capable of cleaning a plurality of solar arrays without water, the cleaning system comprising:
a first set of ground based rails positioned substantially in between two neighboring solar arrays, parallel to a length direction of said plurality of solar arrays;
a second set of ground based rails positioned perpendicularly to said length direction of said plurality of solar arrays;
a moveable transport platform capable of moving along said second set of ground based rails; and
an automatic waterless cleaning apparatus capable of moving along said first set of ground based rails along said length direction of said plurality of solar arrays, positioned on said moveable transport platform,
said second set of ground based rails comprising:
a plurality of sensors,
said moveable transport platform comprising:
two descent rails, coupled with a surface of said moveable transport platform;
a plurality of wheels, for moving said moveable transport platform along said second set of ground based rails;
a position sensor;
a first controller, for controlling the movement of said moveable transport platform; and
a power supply,
said automatic waterless cleaning apparatus comprising:
at least four wheels, for moving said automatic waterless cleaning apparatus along said first set of ground based rails;
a second controller, for controlling a boarding and alighting of said automatic waterless cleaning apparatus from said moveable transport platform;
a transmission; and
at least one electrical motor,
wherein a distance between said at least four wheels is substantially the same as a distance between neighboring ones of said first set of ground based rails.

2. The cleaning system according to claim 1, wherein said power supply is batteries.

3. The cleaning system according to claim 1, wherein said solar park is selected from the list consisting of:
a fixed type solar park; and
a solar tracker type solar park.

4. The cleaning system according to claim 1, wherein a height of said first set of ground based rails is fixed relative to said plurality of solar arrays.

5. The cleaning system according to claim 4, wherein each one of said second set of ground based rails is positioned relative to said height of said first set of ground based rails.

6. The cleaning system according to claim 4, wherein a height of said second set of ground based rails is lower than said height of said first set of ground based rails.

7. The cleaning system according to claim 4, wherein a height of said two descent rails is substantially the same as said height of said first set of ground based rails.

8. The cleaning system according to claim 1, wherein said position sensor and each one of said plurality of sensors forms a sensor couple for accurately positioning said moveable transport platform at predefined parking positions along said second set of ground based rails.

9. The cleaning system according to claim 8, wherein at said predefined parking positions, said position sensor is in line with a given one of said plurality of sensors.

10. The cleaning system according to claim 1, wherein said position sensor and each one of said plurality of sensors are respectively selected from the list consisting of:
a magnetic sensor and a magnet;
a proximity sensor and a piece of metal; and
other types of sensor pairs.

11. The cleaning system according to claim 1, wherein said automatic waterless cleaning apparatus has a bridge form over said plurality of solar arrays.

12. The cleaning system according to claim 1, wherein said automatic waterless cleaning apparatus has an angle parallel to a tilt angle in a fixed type solar park.

13. The cleaning system according to claim 1, wherein said automatic waterless cleaning apparatus has an angle parallel to a predetermined cleaning angle in a solar tracker type solar park.

14. The cleaning system according to claim 1, wherein said automatic waterless cleaning apparatus is positioned on said moveable transport platform by an indicator.

15. The cleaning system according to claim 14, wherein said indicator is selected from the list consisting of:
mechanical stoppers; and
proximity sensors.

16. The cleaning system according to claim 1, wherein in a parking position of said moveable transport platform, said two descent rails form a continuation of two neighboring ones of said first set of ground based rails such that said automatic waterless cleaning apparatus can move seamlessly from said two descent rails to said two neighboring ones of said first set of ground based rails.

17. The cleaning system according to claim 1, said moveable transport platform further comprising:
a transmission; and
at least one electrical motor, for driving said plurality of wheels.

18. The cleaning system according to claim 1, wherein communication between said first controller and said second controller is conducted via a wireless communication protocol.

19. The cleaning system according to claim 18, wherein said wireless communication protocol is selected from the list consisting of:
ZigBee; and
other known communication protocols.

20. Method for operating a cleaning system for solar panels in a solar park capable of cleaning a plurality of solar arrays without water, said cleaning system comprising a first set of ground based rails positioned substantially in between two neighboring solar arrays, parallel to a length direction of said plurality of solar arrays, a second set of ground based rails positioned perpendicularly to said length direction of said plurality of solar arrays, a moveable transport platform capable of moving along said second set of ground based rails and an automatic waterless cleaning apparatus positioned on said moveable transport platform, said second set of ground based rails comprising a plurality of sensors and said moveable transport platform comprising two descent rails, a plurality of wheels for moving said moveable transport platform along said second set of ground based rails, a position sensor, a controller for controlling the movement of said moveable transport platform and a power supply, said method comprising the procedures of:
receiving a start cleaning command by said controller;
moving said moveable transport platform to a first parking position along said second set of ground based rails, said first parking position determined by said controller, said position sensor and said plurality of sensors;
alighting said automatic waterless cleaning apparatus from said moveable transport platform from said two descent rails onto a neighboring two of said first set of ground based rails;
cleaning a first one of said solar arrays using said automatic waterless cleaning apparatus;
boarding said automatic waterless cleaning apparatus onto said moveable transport platform from said neighboring two of said first set of ground based rails onto said moveable transport platform; and
moving said moveable transport platform to a second parking position along said second set of ground based rails.

21. The method for operating a cleaning system according to claim 20, wherein a number of said plurality of solar arrays cleaned without water is limited by a factor selected from the list consisting of:
time;
weather conditions; and
power supply limitations.
